(19) United States
(12) Patent Application Publication
(10) Pub. No.: US 2020/0000669 A1
(43) Pub. Date: Jan. 2, 2020

(54) Vibration Fitness Machine

(71) Applicant: Hung Sheng Electric Industrial Corp., Tainan City (TW)

(72) Inventor: Wen-Chung Tsai, Tainan City (TW)

(21) Appl. No.: 16/451,074

(22) Filed: Jun. 25, 2019

(30) Foreign Application Priority Data
Jun. 28, 2018 (TW) 107122202

(51) Int. Cl. A61H 1/00; A61H 23/02

(52) U.S. Cl. CPC A61H 1/005; A61H 23/0263; A61H 2203/0431; A61H 2201/149; A61H 2023/029

(57) ABSTRACT

The invention is to provide a vibration fitness machine, comprising: a bottom seat, a driving device, two linkage mechanisms, a plurality of eccentric units and an upper cover seat body. The driving device drives the linkage mechanism to act through an eccentric shaft. The linkage mechanism is composed of at least three linkages, wherein the second and third linkages are pivotally connected to a left and right sides of the first linkage, and the middle between the second and third linkages and another end are pivotally connected to a fastening seat and the carrying seat, respectively, through the eccentric unit. The carrying seat is fixedly connected to the upper cover seat body so that the second and third linkages can generate up and down displacement as the same as seesaw-like at left and right sides, capable of driving the upper cover seat body to generate vertical motion as up and down displacement repeatedly, thereby achieving vibration fitness effect.

### BACKGROUND OF THE INVENTION

### Field of the Invention

The present invention relates to a vibration fitness machine, and more particularly to a structure that can be simplified and capable of regulating and changing up and down amplitudes.

### Description of the Related Art

A conventional vibration fitness machine tech, such as Taiwan patent No. TWI302460, enables a left and right support plats of a transmission set to swing through a driving mechanism so as to generate linear vibrations at different kinds of frequencies so that each portion of a human body produces circulation vibration to achieve fitness efficacy. However, the foregoing still has the following shortcomings that need to be overcome.

1. The structure is more complicated. The prior art of Taiwan patent No. TWI302469 uses the driving mechanism to drive a transmission shaft and an eccentric shaft. A first and second support plates can be driven by a transmission member and a linkage member to generate up and down amplitude swing so that an external housing seat body repeatedly produces circulation motion as up and down displacement. Therefore, the transmission set comprises two support plates and two linkage members to cause complexity in structure.
2. One carrying seat in two carrying seats for pivotally connecting and fastening the seat body housing is pivotally connected to the first support plate through a linkage member to show active status while another carrying seat is fixedly connected to the second support plate directly to show fixing status. Therefore, when the two carrying seats drive through the transmission set, it produces up and down displacement as slightly left and right swings and is unable to achieve real vertical motion.
3. The amplitude swing as up and down displacement is stationary and unable to be regulated and changed. The foregoing state is more monotonous and affects fitness effect.

### SUMMARY OF THE INVENTION

Therefore, it is a primary objective of the present invention to provide a vibration fitness machine, in which the structure is simplified, capable of reducing costs and increasing competition capability.

It is another objective of the present invention to provide a vibration fitness machine in which vertical exercise is more certainty to improve fitness effect.

It is a further objective of the present invention to provide a vibration fitness machine capable of regulating and changing up and down amplitudes to increase fitness effect.

To achieve the above-mentioned objective, the present invention comprises a bottom seat; a driving device disposed on the bottom seat and composed of a motor driving a transmission shaft via a variable speed mechanism, tails of two sides of the transmission shaft respectively extended with an eccentric shaft; two linkage mechanism disposed on the bottom seat and located at two sides of the driving device, the linkage mechanism composed of at least three linkages, comprising: a first linkage being erect state, wherein its bottom end is pivotally connected to the eccentric shaft; and a second and third linkages pivotally connected to a left and right sides of the first linkage, one end pivotally connected to an upper end of the first linkage while another end pivotally connected to a carrying seat, respectively, a middle portion pivotally connected to a fastening seat, respectively, the fastening seat fixedly connected on the bottom seat; a plurality of eccentric units disposed to pivot places among the second and third linkages and the carrying seat and the fastening seat and comprising: a bearing; two eccentric rotary discs mutually and correspondingly disposed at two sides of the bearing; and a support rod passing through the two eccentric rotary discs and connected to the carrying seat or the fastening seat; and an upper cover seat body disposed above the bottom seat and fixedly connected to the carrying seat.

According to the above-mentioned vibration fitness machine, the fastening seat is regulated with location.

### BRIEF DESCRIPTION OF THE DRAWINGS

FIG. 1 is a three-dimensional decomposition drawing of opening an upper cover according to the present invention;

FIG. 2 is a three-dimensional decomposition drawing of the bottom seat and the driving device together with the linkage mechanism according to the invention;

FIG. 3 is a three-dimensional decomposition drawing of the linkage mechanism and the eccentric unit according to the invention;

FIG. 4 is a three-dimensional decomposition drawing of the eccentric unit according to the invention;

FIG. 5 is a motion schematic diagram (I) according to the invention;

FIG. 6 is a motion schematic diagram (II) according to the invention;

FIG. 7 is a motion schematic diagram (III) according to the invention;

FIG. 8 is a motion schematic diagram (IV) according to the invention;

FIG. 9 is a schematic diagram of up and down displacement according to the invention;

FIG. 10 is a motion schematic diagram of stand-up usage according to the invention;

FIG. 11 is a motion schematic diagram of sit-down usage according to the invention;

FIG. 12 is a front view (I) according to another embodiment of the invention; and

FIG. 13 is a front view (II) according to a further embodiment of the invention.

### DETAILED DESCRIPTION OF THE PREFERRED EMBODIMENTS

The technical characteristics, contents, advantages and effects of the present invention will be apparent with the detailed description accompanied with related drawings of two preferred embodiments as follows.

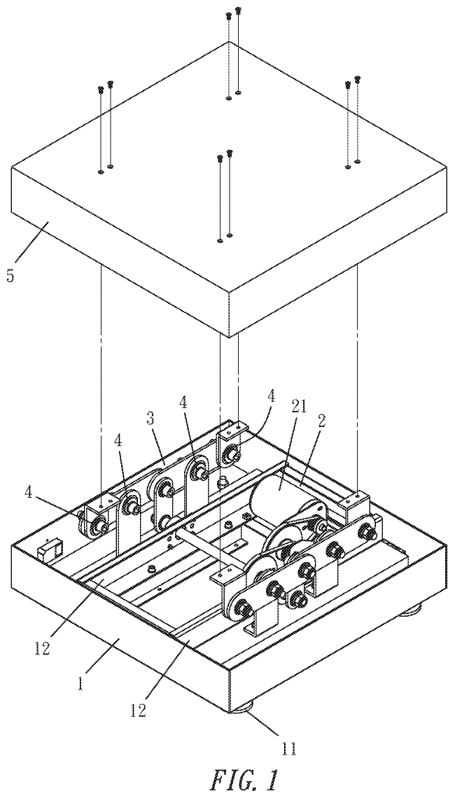

With reference to FIGS. 1˜4, the invention comprises: a bottom seat 1 that is a rectangle or a frame having other shape, wherein the bottom of the bottom seat 1 is disposed with a plurality of foot pads 11, and its inside is also disposed with two seat racks 12 in parallel; a driving device 2 disposed on the bottom seat 1 and having a program and a control circuit and composed of a motor 21 driving a transmission shaft 23 via a variable speed mechanism 22, wherein two sides of the transmission shaft 23 pass through the seat rack 12 and are pivotally connected to the seat rack 12 (through the bearing or the bushing or other connection kits), and the tail of the two sides of the transmission shaft 23 is extended with an eccentric shaft 24, and the variable speed mechanism 22 is composed of two bell wheels; two linkage mechanisms 3 disposed on the bottom seat 1 and located at two sides of the driving device 2 to drive through the driving device 2, wherein the linkage mechanism 3 is composed of at least three linkages, and a single side is selected for description since structure and motion of the linkage mechanisms 3 at two sides are the same.

The linkage mechanism 3 comprise a first linkage 31 that is erect, wherein its bottom end is pivotally connected to the eccentric shaft 24 (through the bearing or the bushing or other connection kits); and a second and third linkages 32, 33, wherein on end is pivotally connected to an upper end of the first linkage 31 (through the bearing or the bushing or other connection kits) so that the second and third linkages 32, 33 are respectively located at left and right sides of the first linkage 31 while another end is pivotally connected to a carrying seat 32, respectively, and the middle is pivotally connected to a fastening seat 35, respectively, and the fastening seat 35 is fixed on the bottom seat 1 to support and position the second and third linkages 32, 33;

A plurality of eccentric units 4 disposed to pivot places among the second and third linkages 32, 33 and the carrying seat 34 and the fastening seat 35 and comprising: a bearing 41, two eccentric rotary discs 42 mutually and correspondingly disposed at two sides of the bearing 41, and a support rod 42 that can be a screw rod passing through the two eccentric rotary discs 32 so that the second and third linkages 32, 33 can be pivotally connected to the carrying seat 34 or the fastening seat 35, respectively;

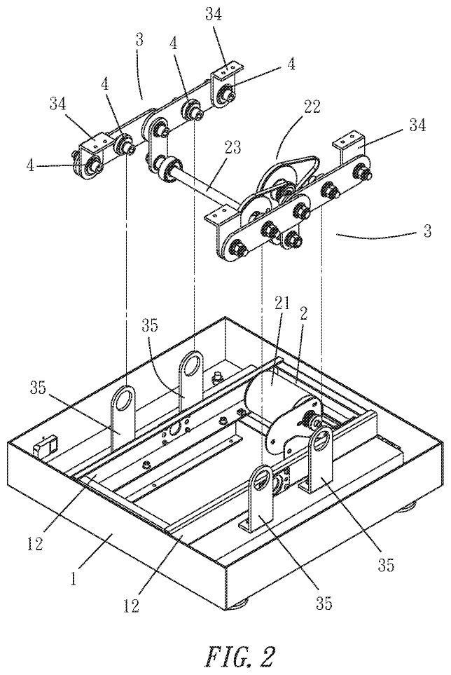

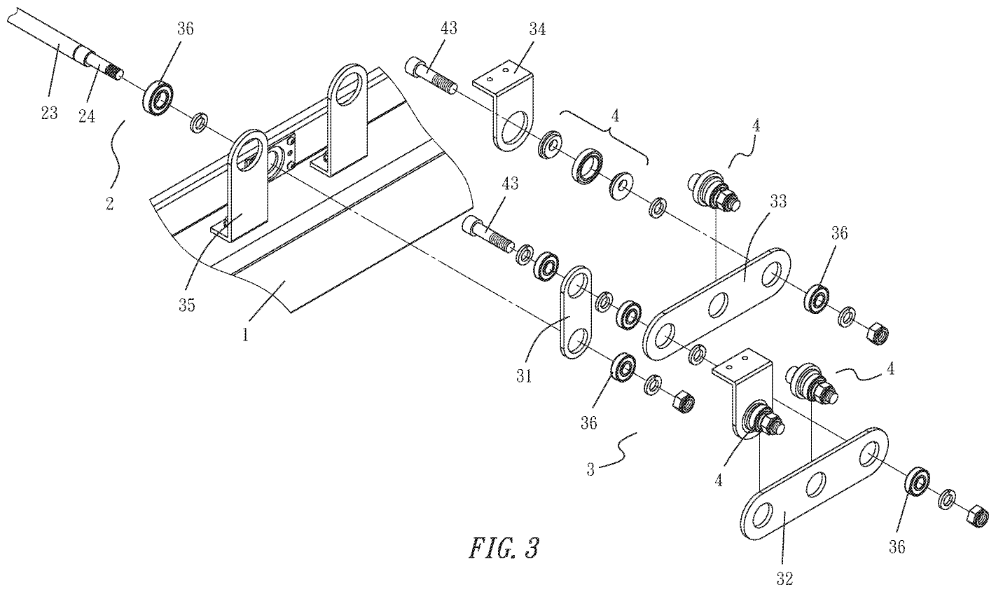

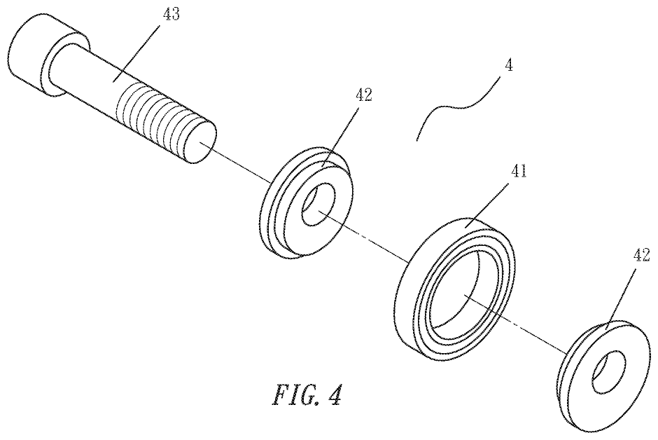

The first, second and third linkages 31, 32, 33 of the linkage mechanism 4 are respectively pivoted with a bearing 36, and the upper end of the first linkage 31 is passed and pivoted by a branch rod 43 to form a first fulcrum a, and the carrying seat 34 and the fastening seat 35 are pivotally disposed with an eccentric unit 4, respectively, and the eccentric unit 4 is passed and pivotally connected by the branch rod 43 together with the bearing 36 of the second and third linkages so that the second and third linkages 32, 33 are pivotally connected to the fastening seat 35 to form second fulcrums b. The second and third linkages 32, 33 are pivotally connected to the carrying seat 34 to form a third fulcrum c of the second and third linkages 32, 33 as shown in FIGS. 2˜5.

An upper cover seat body 5 is disposed above the bottom seat 1, wherein its periphery is fixedly connected to an upper flat panel of the carrying seat 34 so that a user can stand or sit on the surface of the upper cover seat body 5.

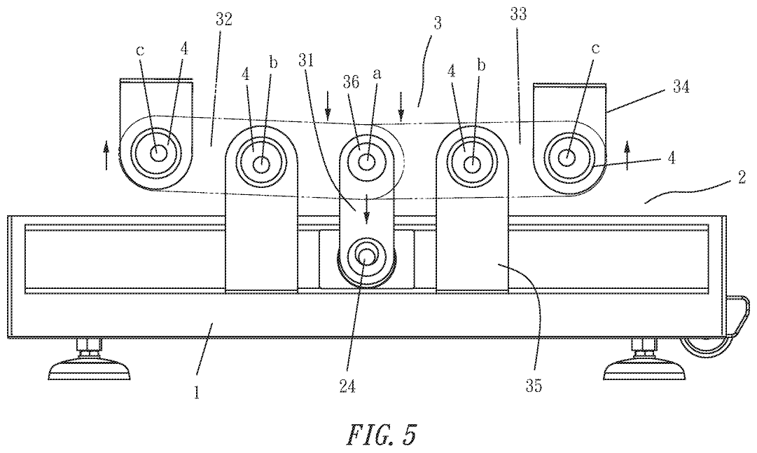

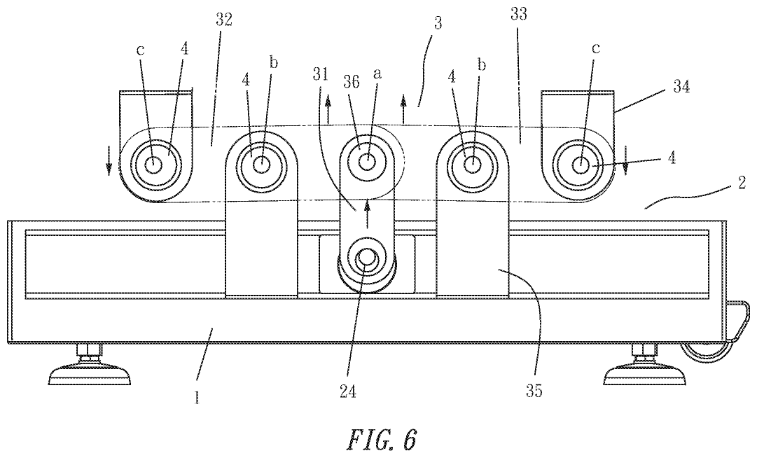

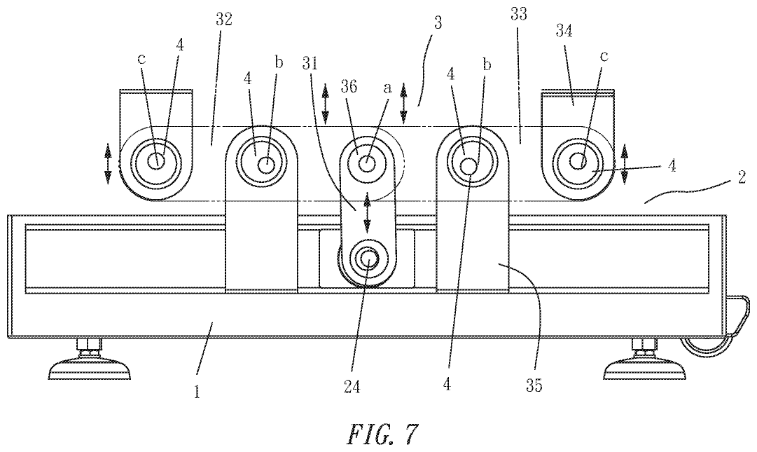

In accordance with the foregoing combination, the second and third linkages 32, 33 of the invention, under normal condition, are respectively located at left and right sides of the first linkage 31 and can be respectively acted. The second and third linkages 32, 33 respectively have the first fulcrum a, the second fulcrums b, and the third fulcrum c. While in activation, it, via the variable speed mechanism 22, drives the transmission shaft 23 to rotate through the motor 21 of the driving device 2. The transmission shaft 23 then drives the linkage mechanism 3 to perform motion through the eccentric shaft 24 so that the first linkage 31 generates circulation motion as left and right swing at the first fulcrum a as shown in FIGS. 5, 6 and the second and third linkages 32, 33 are synchronously and respectively driven to generate vertical displacement as seesaw-like at the second fulcrum b (a place pivotally connected to the fastening seat 35) such that the second and third linkages 32, 33 can synchronously drive the upper cover seat body 5 to generate vertical displacement and vibration by taking the third fulcrum c (a place pivotally connected to the carrying seat 34) even if the upper cover seat body 5 repeatedly generates vertical motion as the same as vertical displacement shown in FIGS. 7˜9.

In the second and third linkages 32, 33 of the linkage mechanism 3, the second fulcrum b at the middle section and the third fulcrum c at another end are respectively pivoted with the eccentric unit 4. When they are driven by the first linkage 31, the carrying seat 34 (the upper cover seat body 5) of the third fulcrum c can generate vertical motion as vertical displacement through eccentric design of the eccentric units 4. It does not only avoid splash phenomenon as left and right swing completely but also eliminates defect of squeezing the bearing as shown in FIGS. 5˜9.

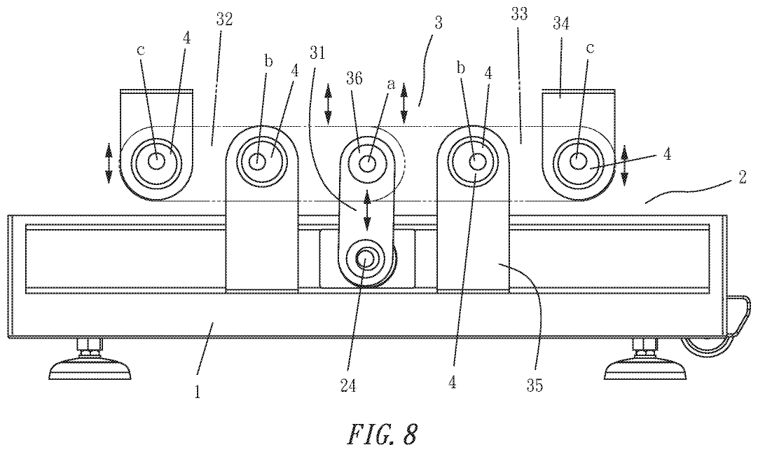

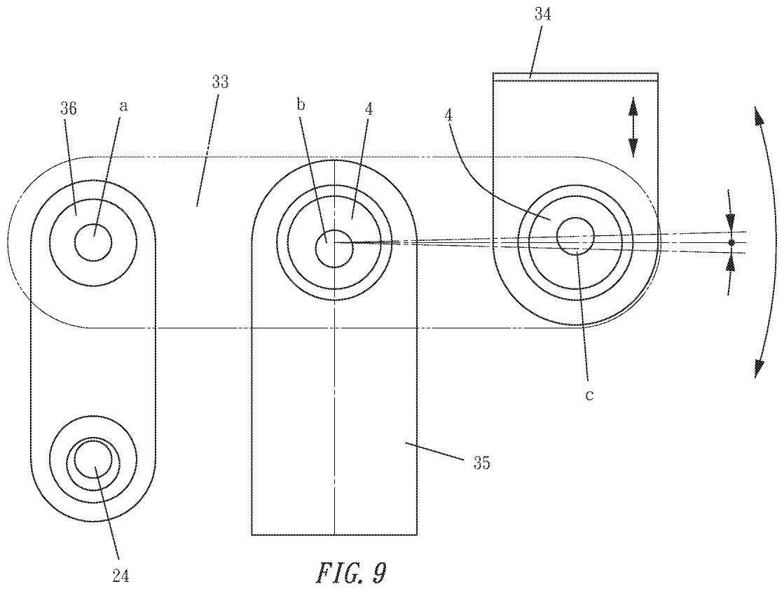

When the eccentric unit 4 of the second fulcrum b and the third fulcrum c of the second and third linkages 32, 33 rotates to reach left and right sides, it can generate regulated distance as shown in FIGS. 7, 8.

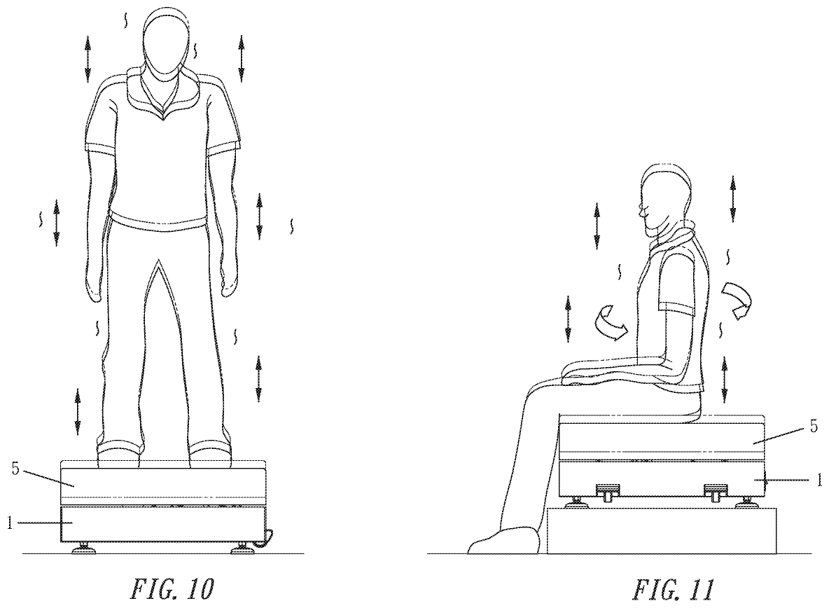

When the user stands or sits on the upper cover seat body 5 as shown in FIGS. 10, 11 or when the invention is combined with machinery such as a massage chair, it, via the linkage mechanism 3, acts through the driving device 2 and incorporates with rotation speed of the motor 21 and the variable speed mechanism 22 so that the upper cover seat body 5 generates up and down displacements at different kinds of frequency vibrations. Furthermore, each portion of the whole body can be circularly and periodically vibrated to achieve fitness effect.

Upon the foregoing illustration, the invention has at least following advantages and efficacies to have inventive steps better than conventional technique:

1. The structure is simplified. Besides necessarily components of the bottom seat 1 and the upper cover seat body 5, the invention can achieve vertical motion as up and down displacement by merely enabling the driving device 2 to drive the linkage mechanism 3 to act. In comparison with the conventional transmission set composed of two plates and two linkage members, the invention is actually and obviously simplified to reduce costs and to enhance competition.
1. The second and third linkages 32, 33 of the linkage mechanism 3 according to the invention are pivotally connected to the carrying seat 34 and the fastening seat 35. While in motion, it can exactly eliminate splash swing from left and right sides to achieve vertical motion as up and down displacement, thereby improving fitness effect.
2. The second and third linkages 32, 33 of the linkage mechanism 3 according to the invention are pivotally connected to the carrying seat 34 and the fastening seat 35. When it is driven by the first linkage 31, the defect of squeezing the bearing can be completely eliminated through eccentric design of the eccentric units 4.

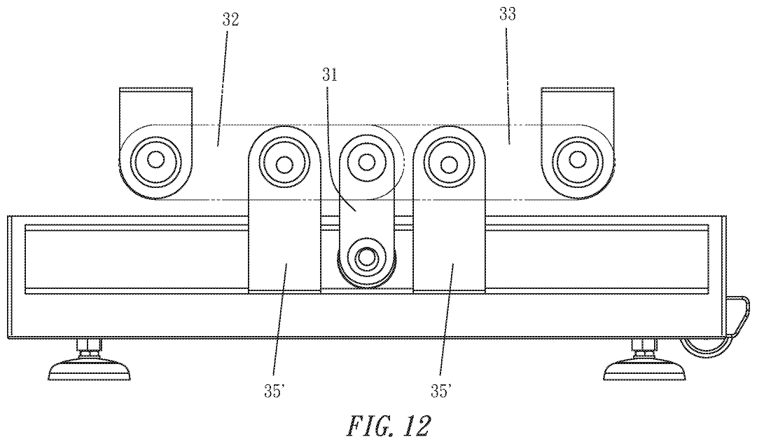

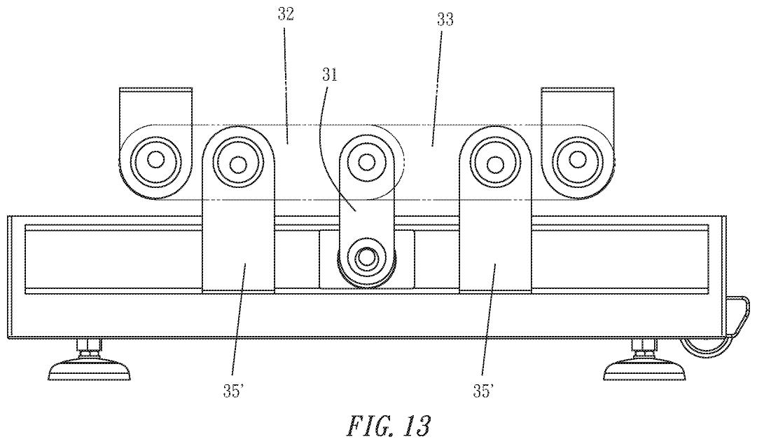

With reference to FIGS. 12, 13, another embodiment of the invention is illustrated. In the embodiment, the fastening seat 35′ can be regulated and changed with its position in accordance with demands. After regulating the fastening seat 35′, an interval between its position and the first linkage 31 can be reduced or stretched to regulate and change amplitudes of up and down displacement of the second and third linkages 32, 33 so that amplitude of up and down displacement of the upper cover seat body 5 can be regulated and changed to achieve better fitness effect.

While the present invention has been described by means of specific embodiments, numerous modifications and variations could be made thereto by those skilled in the art without departing from the scope and spirit of the invention set forth in the claims.

What is claimed is:

1. A vibration fitness machine comprising:
a bottom seat;
a driving device disposed on the bottom seat and composed of a motor driving a transmission shaft via a variable speed mechanism, tails of two sides of the transmission shaft respectively extended with an eccentric shaft;
two linkage mechanism disposed on the bottom seat and located at two sides of the driving device, the linkage mechanism composed of at least three linkages, comprising: a first linkage being erect state, wherein its bottom end is pivotally connected to the eccentric shaft; and a second and third linkages pivotally connected to a left and right sides of the first linkage, one end pivotally connected to an upper end of the first linkage while another end pivotally connected to a carrying seat, respectively, a middle portion pivotally connected to a fastening seat, respectively, the fastening seat fixedly connected on the bottom seat;
a plurality of eccentric units disposed to pivot places among the second and third linkages and the carrying seat and the fastening seat and comprising: a bearing; two eccentric rotary discs mutually and correspondingly disposed at two sides of the bearing; and a support rod passing through the two eccentric rotary discs and connected to the carrying seat or the fastening seat; and
an upper cover seat body disposed above the bottom seat and fixedly connected to the carrying seat.

2. The vibration fitness machine of claim 1, wherein the fastening seat is regulated with location.
